(19) United States
(12) Patent Application Publication
(10) Pub. No.: US 2010/0093969 A1
(43) Pub. Date: Apr. 15, 2010

(54) Process for making siloxane polymers

(76) Inventors: Ruzhi Zhang, Pennington, NJ (US); David Abdallah, Bernardsville, NJ (US); PingHung Lu, Bridgewater, NJ (US); Mark Neisser, Whitehouse Station, NJ (US)

Correspondence Address: AZ ELECTRONIC MATERIALS USA CORP.;ATTENTION: INDUSTRIAL PROPERTY DEPT., 70 MEISTER AVENUE, SOMERVILLE, NJ, 08876, US

(21) Appl. No.: 12/449,750

(22) PCT Filed: Feb. 25, 2008
(86) PCT No.: PCT/IB2008/000518

§ 371 Date: Aug. 24, 2009

Related U.S. Application Data
(60) Provisional application No. 60/891,702, filed on Feb. 26, 2007.
(60) Provisional application No. 61/013,323, filed on Dec. 13, 2007.

(51) Int. Cl. C08G 77/06

(52) U.S. Cl. 528/20

(57) ABSTRACT

The present invention relates to process for making a siloxane polymer which comprises at least one Si—OH group and at least one Si—OR group, where R is a moiety other than hydrogen, comprising reacting one or more silane reactants together in the presence of a hydrolysis catalyst in either a water/alcohol mixture or in one or more alcohols to form the siloxane polymer; and separating the siloxane polymer from the water/alcohol mixture or the alcohol(s).

### FIELD OF INVENTION

The present invention relates to a process for making a siloxane polymer, which is useful in forming absorbing antireflective coating compositions.

### BACKGROUND OF INVENTION

Photoresist compositions are used in microlithography processes for making miniaturized electronic components such as in the fabrication of computer chips and integrated circuits. Generally, in these processes, a thin coating of film of a photoresist composition is first applied to a substrate material, such as silicon wafers used for making integrated circuits. The coated substrate is then baked to evaporate any solvent in the photoresist composition and to fix the coating onto the substrate. The photoresist coated on the substrate is next subjected to an image-wise exposure to radiation.

The radiation exposure causes a chemical transformation in the exposed areas of the coated surface. Visible light, ultraviolet (UV) light, electron beam and X-ray radiant energy are radiation types commonly used today in microlithographic processes. After this image-wise exposure, the coated substrate is treated with a developer solution to dissolve and remove either the radiation exposed (positive photoresist) or the unexposed areas of the photoresist (negative photoresist).

When positive working photoresists are exposed image-wise to radiation, those areas of the photoresist composition exposed to the radiation become more soluble to the developer solution while those areas not exposed remain relatively insoluble to the developer solution. Thus, treatment of an exposed positive-working photoresist with the developer causes removal of the exposed areas of the coating and the formation of a positive image in the photoresist coating. Again, a desired portion of the underlying surface is uncovered.

When negative working photoresists are exposed image-wise to radiation, those areas of the photoresist composition exposed to the radiation become insoluble to the developer solution while those areas not exposed remain relatively soluble to the developer solution. Thus, treatment of a non-exposed negative-working photoresist with the developer causes removal of the unexposed areas of the coating and the formation of a negative image in the photoresist coating. Again, a desired portion of the underlying surface is uncovered.

Photoresist resolution is defined as the smallest feature which the photoresist composition can transfer from the photomask to the substrate with a high degree of image edge acuity after exposure and development. In many leading edge manufacturing applications today, photoresist resolution on the order of less than 100 nm is necessary. In addition, it is almost always desirable that the developed photoresist wall profiles be near vertical relative to the substrate. Such demarcations between developed and undeveloped areas of the photoresist coating translate into accurate pattern transfer of the mask image onto the substrate. This becomes even more critical as the push toward miniaturization reduces the critical dimensions on the devices.

The trend towards the miniaturization of semiconductor devices has led to the use of new photoresists that are sensitive at lower and lower wavelengths of radiation and has also led to the use of sophisticated multilevel systems, such as antireflective coatings, to overcome difficulties associated with such miniaturization.

Photoresists sensitive to short wavelengths, between about 100 nm and about 300 nm, are often used where subhalfmicron geometries are required. Particularly preferred are deep uv photoresists sensitive at below 200 nm, e.g. 193 nm and 157 nm, comprising non-aromatic polymers, a photoacid generator, optionally a dissolution inhibitor, and solvent.

The use of highly absorbing antireflective coatings in photolithography is a useful approach to diminish the problems that result from back reflection of light from highly reflective substrates. The bottom antireflective coating is applied on the substrate and then a layer of photoresist is applied on top of the antireflective coating. The photoresist is exposed imagewise and developed. The antireflective coating in the exposed area is then typically dry etched using various etching gases, and the photoresist pattern is thus transferred to the substrate. In cases where the photoresist does not provide sufficient dry etch resistance, underlayers or antireflective coatings for the photoresist that are highly etch resistant are preferred and one approach has been to incorporate silicon into these underlayers. Silicon is highly etch resistant under etch conditions to remove photoresists and thus these silicon containing antireflective coatings that also absorb the exposure radiation are highly desirable.

The present invention provides a process for making siloxane polymers, which are useful for in antireflective coating compositions. The siloxane polymer is highly absorbing and the polymer preferably also contains a group capable of self crosslinking the polymer in the presence of an acid.

A process for making siloxane polymers, which are useful in antireflective coating compositions, as well as antireflective coating compositions containing such siloxane polymers, are provided. The siloxane polymer is highly absorbing and can be cured with or without the presence of a catalyst at elevated temperatures. Catalysts such as thermal acid generators, photo-acid generators, onium salts (e.g. ammonium/phosphonium salts), and the like (acid generators) can be utilized to catalyze the cross-linking of aforementioned SSQ polymers.

### SUMMARY OF THE INVENTION

The present invention relates to process for making a siloxane polymer which comprises at least one Si—OH group and at least one Si—OR group, where R is a moiety other than hydrogen, comprising reacting one or more silane reactants together in the presence of a hydrolysis catalyst in either a water/alcohol mixture or in one or more alcohols to form the siloxane polymer; and separating the siloxane polymer from the water/alcohol mixture or the alcohol(s).

In a process for making a siloxane polymer,

the silane polymer comprises at least one Si—OH group, at least one Si—OR group, where R is a moiety other than hydrogen, and preferably at least one absorbing chromophore, and at least one moiety selected from structure (1) and structure (2),

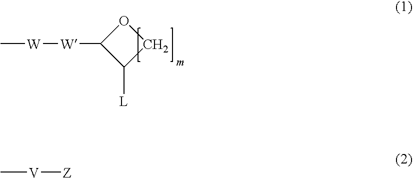

where m is 0 or 1; W and W′ are independently a valence bond or a connecting group linking the cyclic ether to the silicon of the polymer; L is selected from hydrogen, W′ and W, or L and W′ are combined to comprise a cycloaliphatic linking group linking the cyclic ether to the silicon of the polymer; V is a valence bond or a connecting group linking Z to the silicon of the polymer; Z is selected from O—C(═O)—R³⁰, unsubstituted or substituted alkenyl, and —N═C═O; and R³⁰ is unsubstituted or substituted alkyl or unsubstituted or substituted alkenyl,

comprising reacting one or more silane reactants together in the presence of a hydrolysis catalyst in either a water/alcohol mixture or in one or more alcohols to form the siloxane polymer; and separating the siloxane polymer from the water/alcohol mixture or the alcohol(s).

Preferably W and/or W′ are chromophores. Preferably, the silicon content is greater than 15 weight %.

The moieties in structures (1) and (2) can provide self-crosslinking functionality and examples include epoxide, oxetane, acrylate, vinyl, (trisiloxanyl)silylethyl acetate, and the like, and the chromophore can be selected from unsubstituted aromatic, substituted aromatic, unsubstituted heteroaromatic and substituted heteroaromatic moiety. The siloxane polymer may comprise at least units of (i) and/or (ii) of the structure,

—(R¹SiO_{h/2})— and —(R²SiO_{h/2})— (i), where h is 1, 2, or 3,

—(R′(R″)SiO_{X})— (ii),

where R¹ is independently a moiety selected from structure (1) and structure (2),

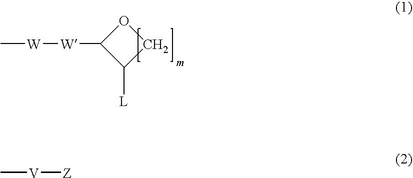

where m is 0 or 1; W and W′ are independently a valence bond or a connecting group linking the cyclic ether to the silicon of the polymer; L is selected from hydrogen, W′ and W, or L and W′ are combined to comprise a cycloaliphatic linking group linking the cyclic ether to the silicon of the polymer; V is a valence bond or a connecting group linking Z to the silicon of the polymer; Z is selected from O—C(═O)—R³⁰, unsubstituted or substituted alkenyl, and —N═C═O; and R³⁰ is unsubstituted or substituted alkyl or unsubstituted or substituted alkenyl, R² is a chromophore, R′ and R″ are independently selected from R¹ and R², and x=½ or 1.

In addition, the siloxane polymer can also comprise units selected from

-(A¹R¹SiO_{X})— (iii), and

-(A²R²SiO_{X})— (iv),

where, R¹ is moiety selected from structure (1) and structure (2),

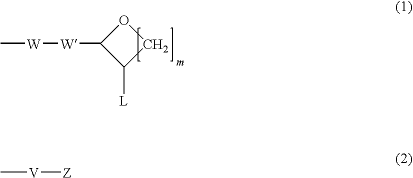

where m is 0 or 1; W and W′ are independently a valence bond or a connecting group linking the cyclic ether to the silicon of the polymer; L is selected from hydrogen, W′ and W, or L and W′ are combined to comprise a cycloaliphatic linking group linking the cyclic ether to the silicon of the polymer; V is a valence bond or a connecting group linking Z to the silicon of the polymer; Z is selected from —O—C(═O)—R³⁰, unsubstituted or substituted alkenyl, and —N═C═O; and R³⁰ is unsubstituted or substituted alkyl or unsubstituted or substituted alkenyl; x=½ or 1; A¹ and A² are independently hydroxyl, R¹, R², halide, alkyl, OR⁴, OC(O)R⁴, unsubstituted or substituted alkylketoxime, unsubstituted aryl and substituted aryl, unsubstituted or substituted alkylaryl, unsubstituted or substituted alkoxy, unsubstituted or substituted acyl and unsubstituted or substituted acyloxy, and R⁴ is selected from alkyl, unsubstituted aryl and substituted aryl;

—(R³SiO_{h/2})— (v),

where h is 1, 2, or 3; and R³ is independently, hydroxyl, hydrogen, halide, alkyl, OR⁴, OC(O)R⁴, unsubstituted or substituted alkylketoxime, unsubstituted or substituted aryl, unsubstituted or substituted alkylaryl, unsubstituted or substituted alkoxy, unsubstituted or substituted acyl and unsubstituted or substituted acyloxy, where R⁴ is selected from unsubstituted or substituted alkyl, unsubstituted aryl and substituted aryl;

—(SiO_{4/2})— (vi),

-((A¹)A²SiOₓ)— (vii),

where x=½ or 1, A¹ and A² are independently hydroxyl, hydrogen, halide, alkyl, OR⁴, OC(O)R⁴, unsubstituted or substituted alkylketoxime, unsubstituted or substituted aryl, unsubstituted or substituted alkoxy, unsubstituted or substituted alkylaryl, unsubstituted or substituted acyl and unsubstituted or substituted acyloxy; and mixtures of these units;

—(R⁵SiO_{h/2})— (viii),

where h is 1, 2, or 3; and R⁵ is a moiety comprising a self-crosslinking group of structure (1) or structure (2) and an absorbing chromophore,

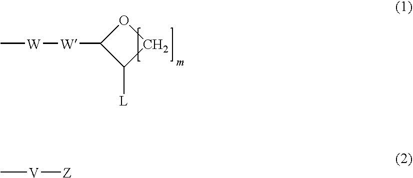

where m is 0 or 1; W and W′ are independently a valence bond or a connecting group linking the cyclic ether to the silicon of the polymer; L is selected from hydrogen, W′ and W, or L and W′ are combined to comprise a cycloaliphatic linking group linking the cyclic ether to the silicon of the polymer; V is a valence bond or a connecting group linking Z to the silicon of the polymer; Z is selected from O—C(═O)—R³⁰, unsubstituted or substituted alkenyl, and —N═C═O; and R³⁰ is unsubstituted or substituted alkyl or unsubstituted or substituted alkenyl;

—(R¹SiO_{3/2})ₐ(R²SiO_{3/2})_{b}(R³SiO_{3/2})_{c}(SiO_{4/2})_{d}—

where, R¹ is independently a moiety selected from structure (1) and structure (2),

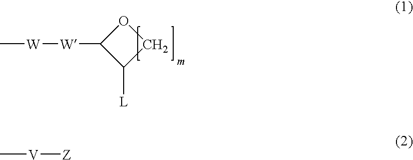

where m is 0 or 1; W and W′ are independently a valence bond or a connecting group linking the cyclic ether to the silicon of the polymer; L is selected from hydrogen, W′ and W, or L and W′ are combined to comprise a cycloaliphatic linking group linking the cyclic ether to the silicon of the polymer; V is a valence bond or a connecting group linking Z to the silicon of the polymer; Z is selected from O—C(═O)—R³⁰, unsubstituted or substituted alkenyl, and —N═C═O; and R³⁰ is unsubstituted or substituted alkyl or unsubstituted or substituted alkenyl; R² is a chromophore; R³ is independently, hydrogen, (C₁-C₁₀) alkyl, unsubstituted aryl, and, substituted aryl radical; and 0<a<1; 0≦b<1, 05≦c<1; and 0≦d<1.

In addition, antireflective coating compositions comprising siloxane polymers made by the above process and an acid generator are also provided. The acid generator is preferably a thermal acid generator. The acid generator is preferably selected from an iodonium salt, sulfonium salt and ammonium salt.

### DETAILED DESCRIPTION OF THE INVENTION

The present invention relates to process for making a siloxane polymer which comprises at least one Si—OH group and at least one Si—OR group, where R is a moiety other than hydrogen, comprising reacting one or more silane reactants together in the presence of a hydrolysis catalyst in either a water/alcohol mixture or in one or more alcohols to form the siloxane polymer; and separating the siloxane polymer from the water/alcohol mixture or the alcohol(s).

A process for making a siloxane polymer,

the silane polymer comprises at least one Si—OH group, at least one Si—OR group, where R is a moiety other than hydrogen, at least one absorbing chromophore, and at least one moiety selected from structure (1) and structure (2),

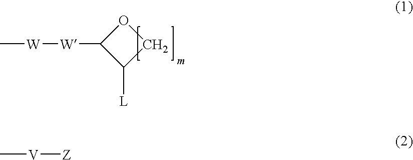

where m is 0 or 1; W and W′ are independently a valence bond or a connecting group linking the cyclic ether to the silicon of the polymer; L is selected from hydrogen, W′ and W, or L and W′ are combined to comprise a cycloaliphatic linking group linking the cyclic ether to the silicon of the polymer; V is a valence bond or a connecting group linking Z to the silicon of the polymer; Z is selected from O—C(═O)—R³⁰, unsubstituted or substituted alkenyl, and —N═C═O; and R³⁰ is unsubstituted or substituted alkyl or unsubstituted or substituted alkenyl,

comprising reacting one or more silane reactants together in the presence of a hydrolysis catalyst in either a water/alcohol mixture or in one or more alcohols to form the siloxane polymer; and separating the siloxane polymer from the water/alcohol mixture or the alcohol(s) is preferably provided.

The moieties in structures (1) and (2) can provide self-crosslinking functionality and examples include epoxide, for example cycloaliphatic epoxide, oxetane, acrylate, vinyl, (trisiloxanyl)silylethyl acetate, and the like, and the chromophore can be selected from unsubstituted aromatic, substituted aromatic, unsubstituted heteroaromatic and substituted heteroaromatic moiety. The siloxane polymer may comprise at least units of (i) and/or (ii) of the structure,

—(R¹SiO_{n/2})— and —(R²SiO_{h/2})— (i), where h is 1, 2, or 3,

—(R′(R″)SiO_{X})— (ii),

where R¹ is independently a moiety selected from structure (1) and structure (2),

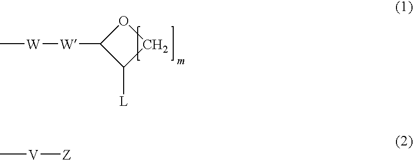

where m is 0 or 1; W and W′ are independently a valence bond or a connecting group linking the cyclic ether to the silicon of the polymer; L is selected from hydrogen, W′ and W, or L and W′ are combined to comprise a cycloaliphatic linking group linking the cyclic ether to the silicon of the polymer; V is a valence bond or a connecting group linking Z to the silicon of the polymer; Z is selected from O—C(═O)—R³⁰, unsubstituted or substituted alkenyl, and —N═C═O; and R³⁰ is unsubstituted or substituted alkyl or unsubstituted or substituted alkenyl, R² is a chromophore, R′ and R″ are independently selected from R¹ and R², and x=½ or 1.

In addition, the siloxane polymer can also comprise units selected from

-(A¹R¹SiO_{X})— (iii), and

-(A²R²SiO_{X})— (iv),

where, R¹ is moiety selected from structure (1) and structure (2),

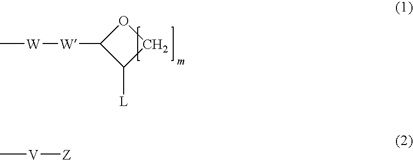

where m is 0 or 1; W and W′ are independently a valence bond or a connecting group linking the cyclic ether to the silicon of the polymer; L is selected from hydrogen, W′ and W, or L and W′ are combined to comprise a cycloaliphatic linking group linking the cyclic ether to the silicon of the polymer; V is a valence bond or a connecting group linking Z to the silicon of the polymer; Z is selected from O—C(═O)—R³⁰, unsubstituted or substituted alkenyl, and —N═C═O; and R³⁰ is unsubstituted or substituted alkyl or unsubstituted or substituted alkenyl; x=½ or 1; A¹ and A² are independently hydroxyl, R¹, R², halide, alkyl, OR⁴, OC(O)R⁴, unsubstituted or substituted alkylketoxime, unsubstituted aryl and substituted aryl, unsubstituted or substituted alkylaryl, unsubstituted or substituted alkoxy, unsubstituted or substituted acyl and unsubstituted or substituted acyloxy, and R⁴ is selected from unsubstituted or substituted alkyl, unsubstituted aryl and substituted aryl;

—(R³SiO_{h/2})— (v),

where h is 1, 2, or 3; and R³ is independently, hydroxyl, hydrogen, halide, alkyl, OR⁴, OC(O)R⁴, unsubstituted or substituted alkylketoxime, unsubstituted or substituted aryl, unsubstituted or substituted alkylaryl, unsubstituted or substituted alkoxy, unsubstituted or substituted acyl and unsubstituted or substituted acyloxy, where R⁴ is selected from unsubstituted or substituted alkyl, unsubstituted aryl and substituted aryl,

—(SiO_{4/2})— (vi),

-((A₁)A²SiO_{X})— (vii),

where x=½ or 1, A¹ and A² are independently hydroxyl, hydrogen, halide, alkyl, OR⁴, OC(O)R⁴, unsubstituted or substituted alkylketoxime, unsubstituted or substituted aryl, unsubstituted or substituted alkoxy, unsubstituted or substituted alkylaryl, unsubstituted or substituted acyl and unsubstituted or substituted acyloxy; and mixtures of these units.

—(R⁵SiO_{h/2})— (viii),

where h is 1, 2, or 3; and R⁵ is a moiety comprising a self-crosslinking group of structure (1) or structure (2) and an absorbing chromophore,

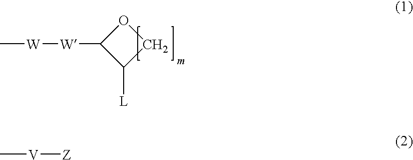

where m is 0 or 1; W and W′ are independently a valence bond or a connecting group linking the cyclic ether to the silicon of the polymer; L is selected from hydrogen, W′ and W, or L and W′ are combined to comprise a cycloaliphatic linking group linking the cyclic ether to the silicon of the polymer; V is a valence bond or a connecting group linking Z to the silicon of the polymer; Z is selected from O—C(═O)—R³⁰, unsubstituted or substituted alkenyl, and —N═C═O; and R³⁰ is unsubstituted or substituted alkyl or unsubstituted or substituted alkenyl;

—(R¹SiO_{3/2})ₐ(R²SiO_{3/2})_{b}(R³SiO_{3/2})_{c}(SiO_{4/2})_{d}—

where, R¹ is independently a moiety selected from structure (1) and structure (2),

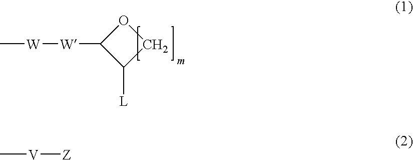

where m is 0 or 1; W and W′ are independently a valence bond or a connecting group linking the cyclic ether to the silicon of the polymer; L is selected from hydrogen, W′ and W, or L and W′ are combined to comprise a cycloaliphatic linking group linking the cyclic ether to the silicon of the polymer; V is a valence bond or a connecting group linking Z to the silicon of the polymer; Z is selected from O—C(═O)—R³⁰, unsubstituted or substituted alkenyl, and —N═C═O; and R³⁰ is unsubstituted or substituted alkyl or unsubstituted or substituted alkenyl; R² is a chromophore; R³ is independently, hydrogen, unsubstituted or substituted (C₁-C₁₀)alkyl, unsubstituted aryl, and, substituted aryl radical; and 0<a<1; 0<b<1, 0≦c<1; and 0≦d<1.

In addition, antireflective coating compositions comprising siloxane polymers made by the above process and an acid generator are also provided.

The siloxane polymers made by the process herein are useful in forming antireflective coating compositions useful as an underlayer for a photoresist. The antireflective coating composition can comprise an acid generator and the siloxane polymer made by the process herein. The self-crosslinking functionality of the siloxane polymer can be cyclic ether, such as an epoxide or an oxetane, or a vinyl or those formed by structure (2). The chromophore in the siloxane polymer can be an aromatic functionality. The antireflective coating composition is useful for imaging photoresists that are sensitive to wavelength of radiation ranging from about 300 nm to about 100 nm, such as 193 nm and 157 nm.

Although the preparation of silsesquioxane (SSQ) polymers containing Si—OH moiety is well known in the art, the shelf life of these materials has been an issue due to the self-condensation of Si—OH at room temperature or above.

SSQ polymers are frequently synthesized in a non-alcohol solvent. It has been discovered that using an alcohol solvent is a better solvent than non-alcohol solvent in order to obtain a SSQ polymer containing both Si—OH and Si—OR moieties and chromophores. The SSQ polymers can be cured at elevated temperatures if cure is obtained through the condensation reaction involving Si—OH. Otherwise, catalysts such as thermal acid generators, photo-acid generators, onium salts (e.g. ammonium/phosphonium salts), and the like (acid generators) can be utilized to catalyze the cross-linking of aforementioned SSQ polymers.

The silane reactants are reacted together in either a water/alcohol mixture or in one or more alcohols. Examples of useful alcohols include ethanol, isopropanol, n-butanol, isobutanol, t-butanol, 1,2-propanediol, 1,2,3-propanetriol, ethyl lactate, propylene glycol monomethyl ether and other propylene glycol monoalkyl ethers (e.g., propylene glycol monopropyl ether), 2-ethoxyethanol, 1-methoxy-2-propanol, 2-methyl-2-propanol, and the like, and mixtures thereof.

The inventors have found that siloxane polymers made using the present process herein have little (less than about 25% change and in some instances, less than about 15% change or even less than about 10% or about 5% change) or about no change in weight average molecular weight after being aged at 40° C. for seven days.

In one embodiment the polymer comprises any number of units (i) to (viii), providing there is an absorbing group and a crosslinking group of structure (1) or (2) attached to a siloxane polymer. In another embodiment the polymer comprises units (i) and (v).

One example of the polymer may comprise the structure,

—(R¹SiO_{3/2})ₐ(R²SiO_{3/2})_{b}(R³SiO_{3/2})_{c}(SiO_{4/2})_{d}—

where, R¹ is independently a moiety selected from structure (1) and structure (2),

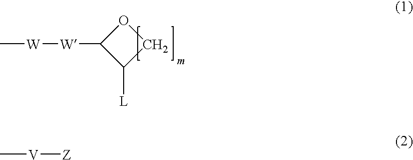

where m is 0 or 1; W and W′ are independently a valence bond or a connecting group linking the cyclic ether to the silicon of the polymer; L is selected from hydrogen, W′ and W, or L and W′ are combined to comprise a cycloaliphatic linking group linking the cyclic ether to the silicon of the polymer; V is a valence bond or a connecting group linking Z to the silicon of the polymer; Z is selected from O—C(═O)—R³⁰, unsubstituted or substituted alkenyl, and —N═C═O; and R³⁰ is unsubstituted or substituted alkyl or unsubstituted or substituted alkenyl, R² is chromophore, R³ is independently selected from hydroxyl, hydrogen, halide (such as fluoride and chloride), unsubstituted or substituted alkyl, OR⁴, OC(O)R⁴, unsubstituted or substituted alkylketoxime, unsubstituted or substituted aryl, unsubstituted or substituted alkylaryl, unsubstituted or substituted alkoxy, unsubstituted or substituted acyl and unsubstituted or substituted acyloxy; where R⁴ is selected from unsubstituted or substituted alkyl, unsubstituted aryl and substituted aryl; 0<a<1; 0<b<1; 0≦c<1; 0≦d<1. In one embodiment of the polymer the concentration of the monomeric units are defined by 0.1<a<0.9, 0.05<b<0.75, 0.1<c and/or d<0.8.

The siloxane polymer comprises a crosslinking group, R¹, for example, cyclic ethers which are capable of crosslinking with other cyclic ether groups in the presence of acids, especially strong acids. Cyclic ethers can be exemplified by the structure (1):

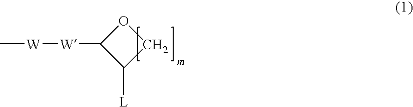

where m is 0 or 1, W and W′ are independently a valence bond or a connecting group linking the cyclic ether to the silicon of the polymer and L is selected from hydrogen, W′ and W, or L and W′ are combined to comprise a cycloaliphatic linking group linking the cyclic ether to the silicon of the polymer. Cyclic ethers are capable of self-crosslinking to form a crosslinked polymer. The cyclic ether group is referred to as an epoxide or oxirane when m=0, and referred to as oxetane when m=1. In one embodiment the cyclic ether is an epoxide. The epoxide or oxetane may be connected directly to the silicon of the polymer. Alternatively, the cyclic ether of structure (1) may be attached to the siloxane polymer through one or more connecting group(s), W and W′. Examples of W and W′ are independently a substituted or unsubstituted (C₁-C₂₄) aryl group, a substituted or unsubstituted (C₁-C₂₀) cycloaliphatic group, a linear or branched (C₁-C₂₀) substituted or unsubstituted aliphatic alkylene group, (C₁-C₂₀) alkyl ether, (C₁-C₂₀) alkyl carboxyl, W′ and L combine to comprise a substituted or unsubstituted (C₁-C₂₀) cycloaliphatic group, and mixtures thereof. In addition, W and W′ can also be an absorbing chromophore such that structure (1) or structure (2) and the absorbing chromophore are in the same unit. The cyclic ether may be linked to the silicon of the polymer through a combination of various types of connecting groups, that is an alkylene ether and a cycloaliphatic group, an alkylene carboxyl and a cycloaliphatic group, an alkylene ether and alkylene group, aryl alkylene group, and aryl alkylene ether group. The pendant cyclic ether crosslinking groups attached to the silicon of the polymer are shown below. In one embodiment the cyclic ether crosslinking group is attached to the siloxane polymer as at least one substituted or unsubstituted biscycloaliphatic group where the cyclic ether forms a common bond (referred to as a cycloaliphatic ether), i.e. the cyclic ether shares a common bond with the cycloaliphatic group (L and W′ are linked to comprise a cyclic, preferably a cycloaliphatic, group), where the cyclic ether is preferably an epoxide (referred to as a cycloaliphatic epoxide) as shown in below. The cycloaliphatic epoxide group may be attached to the silicon atom of the polymer either directly or through one or more connecting groups, W, as described above. Some examples of cycloaliphatic groups are substituted or unsubstituted monocyclic or substituted or unsubstituted multicyclic groups such as cyclohexyl, cycloheptyl, cyclooctyl, norbornyl, etc.

Other moieties which can also crosslinking include those of structure (2)

—V—Z (2)

where V is a valence bond or a connecting group linking Z to the silicon of the polymer; Z is selected from O—C(═O)—R³⁰, alkenyl, and —N═C═O; and R³⁰ is alkyl or alkenyl. Examples of V includes those aforementioned for W, such as, for example, a substituted or unsubstituted (C₁-C₂₄) aryl group, a substituted or unsubstituted (C₁-C₂₀) cycloaliphatic group, a linear or branched (C₁-C₂₀) substituted or unsubstituted aliphatic alkylene group, (C₁-C₂₀) alkyl ether, (C₁-C₂₀) alkyl carboxyl. When Z is O—C(═O)—R³⁰ and R³⁰ is alkenyl, one example material is 3-(trimethoxysilyl)propyl methacrylate. In the presence of a radical initiator, the methacrylate entity will react with other methacrylate entities within the polymer to crosslink. Additionally, when Z is alkenyl, other example materials include trimethoxy(vinyl)silane, triethoxy(vinyl)silane, triethoxy(allyl)silane. Another example of a compound is (vinylphenyl)ethyltriethoxysilane (which can be made following the procedure in U.S. Pat. No. 3,480,584, the contents of which are hereby incorporated herein by reference).

The siloxane polymer also comprises a chromophore group, e.g. R², which is an absorbing group which absorbs the radiation used to expose the photoresist, and such chromophore groups can be exemplified by aromatic functionalities or heteroaromatic functionalities. Further examples of the chromophore are without limitation, a substituted or unsubstituted phenyl group, a substituted or unsubstituted anthracyl group, a substituted or unsubstituted phenanthryl group, a substituted or unsubstituted naphthyl group, a sulfone-based compound, benzophenone-based compound, a substituted or an unsubstituted heterocyclic aromatic ring containing heteroatoms selected from oxygen, nitrogen, sulfur; and a mixture thereof. Specifically, the chromophore functionality can be bisphenylsulfone-based compounds, naphthalene or anthracene based compounds having at least one pendant group selected from hydroxy group, carboxyl group, hydroxyalkyl group, alkyl, alkylene, etc. Examples of the chromophore moiety are also given in US 2005/0058929. More specifically the chromophore may be phenyl, benzyl, hydroxyphenyl, 4-methoxyphenyl, 4-acetoxyphenyl, t-butoxyphenyl, t-butylphenyl, alkylphenyl, chloromethylphenyl, bromomethylphenyl, 9-anthracene methylene, 9-anthracene ethylene, 9-anthracene methylene, and their equivalents. In one embodiment a substituted or unsubstituted phenyl group is used.

As examples the pendant group could be cycloaliphatic epoxides or glycidyl epoxides as shown below.

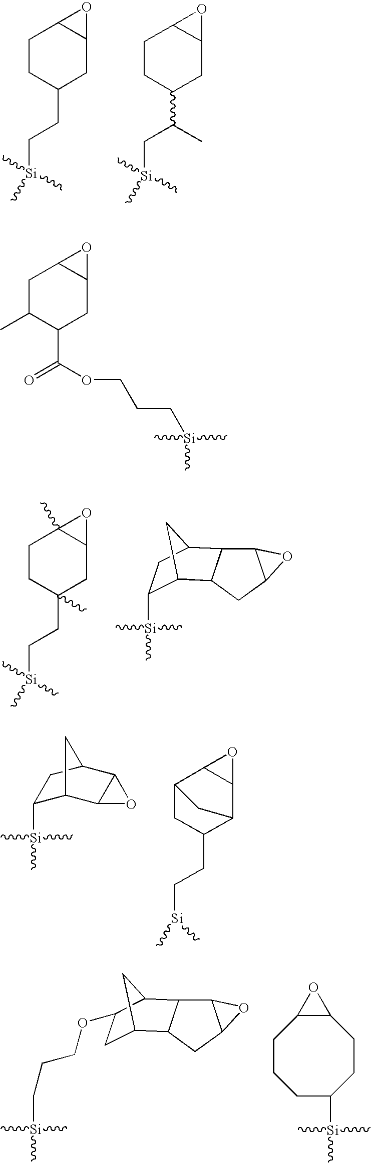

### Examples of Cycloaliphatic Epoxides

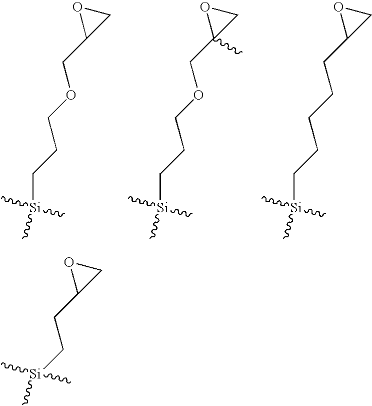

### Examples of Aliphatic Epoxides

In one embodiment the crosslinking cyclic ether group and the chromophore may be within one moiety attached to the siloxane polymer backbone, where the siloxane polymer has been described previously. This moiety may be described by the structure (R⁵SiOₓ), where R⁵ is a moiety comprising a self-crosslinking cyclic ether group of structure (1) and an absorbing chromophore, and x=½, 1 or 3/2. In the polymer the aromatic chromophore group may be one described previously with pendant cyclic ether group of structure (1). As examples the pendant group could be epoxides as shown below.

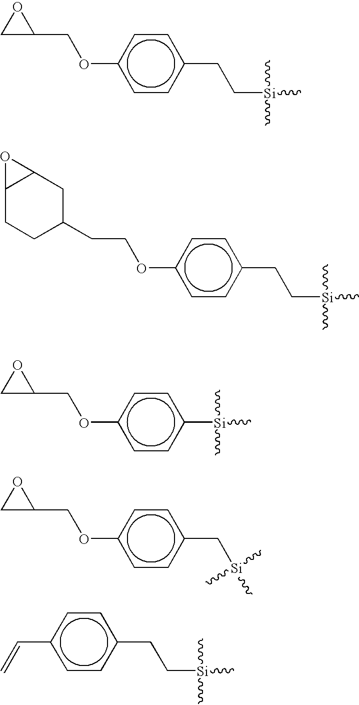

### Examples of Moieties with Chromophore and Crosslinkable Groups, e.g. Epoxides

Other silicon units such as described by structures (i) to (viii) may also be present.

The polymers made by the present process have a weight average molecular weight from about 1,000 to about 500,000, preferably from about 2,000 to about 50,000, more preferably from about 3,000 to about 30,000.

The siloxane polymer has a silicon content of greater than 15 weight %, preferable greater than 20 weight %, and more preferably greater than 30 weight %.

In the above definitions and throughout the present specification, unless otherwise stated the terms used are described below.

Alkyl means linear or branched alkyl having the desirable number of carbon atoms and valence. The alkyl group is generally aliphatic and may be cyclic (cycloaliphatic) or acyclic (i.e. noncyclic), either of which can be unsubstituted or substituted. Suitable acyclic groups can be methyl, ethyl, n- or iso-propyl, n-, iso-, or tert-butyl, linear or branched pentyl, hexyl, heptyl, octyl, decyl, dodecyl, tetradecyl and hexadecyl. Unless otherwise stated, alkyl refers to 1-10 carbon atom moiety. The cyclic alkyl (cycloaliphatic) groups may be mono cyclic or polycyclic. Suitable examples of mono-cyclic alkyl groups include unsubstituted or substituted cyclopentyl, cyclohexyl, and cycloheptyl groups. The substituents may be any of the acyclic alkyl groups described herein. Suitable bicyclic alkyl groups include substituted bicycle[2.2.1]heptane, bicyclo[2.2.2]octane, bicyclo[3.2.1]octane, bicyclo[3.2.2]nonane, and bicyclo[3.3.2]decane, and the like. Examples of tricyclic alkyl groups include tricyclo[5.4.0.0.^{2,9}]undecane, tricyclo[4.2.1.2.^{7,9}]undecane, tricyclo[5.3.2.0.⁴.9]dodecane, and tricyclo[5.2.1.0.^{2,6}]decane. As mentioned herein the cyclic alkyl groups may have any of the acyclic alkyl groups as substituents.

Alkylene groups are divalent alkyl groups derived from any of the alkyl groups mentioned hereinabove. When referring to alkylene groups, these include an alkylene chain substituted with (C₁-C₁₀) alkyl groups in the main carbon chain of the alkylene group. Essentially an alkylene is a divalent hydrocarbon group as the backbone. Accordingly, a divalent acyclic group may be methylene, 1,1- or 1,2-ethylene, 1,1-, 1,2-, or 1,3 propylene, 2,5-dimethyl-2,5-hexene, 2,5-dimethyl-2,5-hex-3-yne, and so on. Similarly, a divalent cyclic alkyl group may be 1,2- or 1,3-cyclopentylene, 1,2-, 1,3-, or 1,4-cyclohexylene, and the like. A divalent tricyclo alkyl groups may be any of the tricyclic alkyl groups mentioned herein above. One example of a tricyclic alkyl group is 4,8-bis(methylene)-tricyclo[5.2.1.0.^{2,6}]decane.

Aryl or aromatic groups contain 6 to 24 carbon atoms including phenyl, tolyl, xylyl, naphthyl, anthracyl, biphenyls, bis-phenyls, tris-phenyls and the like. These aryl groups may further be substituted with any of the appropriate substituents e.g. alkyl, alkoxy, acyl or aryl groups mentioned hereinabove. Similarly, appropriate polyvalent aryl groups as desired may be used herein. Representative examples of divalent aryl groups include phenylenes, xylylenes, naphthylenes, biphenylenes, and the like.

Alkenyl means unsubstituted or substituted hydrocarbon chain radicals having from 2 to 10 carbon atoms having at least one olefinic double bond, e.g. allyl, vinyl, —C(CH₃)═CH₂, etc.

Alkoxy means straight or branched chain alkoxy having 1 to 10 carbon atoms, and includes, for example, methoxy, ethoxy, n-propoxy, isopropoxy, n-butoxy, isobutoxy, tert-butoxy, pentyloxy, hexyloxy, heptyloxy, octyloxy, nonanyloxy, decanyloxy, 4-methylhexyloxy, 2-propylheptyloxy, 2-ethyloctyloxy and phenyloxy.

Aralkyl means aryl groups with attached substituents. The substituents may be any such as alkyl, alkoxy, acyl, etc. Examples of monovalent aralkyl having 7 to 24 carbon atoms include phenylmethyl, phenylethyl, diphenylmethyl, 1,1- or 1,2-diphenylethyl, 1,1-, 1,2-, 2,2-, or 1,3-diphenylpropyl, and the like. Appropriate combinations of substituted aralkyl groups as described herein having desirable valence may be used as a polyvalent aralkyl group.

Furthermore, and as used herein, the term “substituted” is contemplated to include all permissible substituents of organic compounds. In a broad aspect, the permissible substituents include acyclic and cyclic, branched and unbranched, carbocyclic and heterocyclic, aromatic and non-aromatic substituents of organic compounds. Illustrative substituents include, for example, those described hereinabove. The permissible substituents can be one or more and the same or different for appropriate organic compounds. The heteroatoms such as nitrogen may have hydrogen substituents and/or any permissible substituents of organic compounds described herein which satisfy the valencies of the heteroatoms. It is not intended to be limited in any manner by the permissible substituents of organic compounds.

The siloxane polymer is made by reacting at least one silane reactant in either a water/alcohol mixture or in one or more alcohols in the presence of a hydrolysis catalyst to form the siloxane polymer. The ratio of the various types of substituted and unsubstituted silanes used to form the novel siloxane polymer is varied to provide a polymer with the desirable structure and properties. The silane compound containing the chromophoric unit can vary from about 5 mole % to about 90 mole %, preferably from about 5 mole % to about 75 mole %; the silane compound containing the crosslinking unit can vary from about 5 mole % to about 90 mole %, preferably from about 10 mole % to about 90 mole %. The hydrolysis catalyst can be a base or an acid, exemplified by mineral acid, organic carboxylic acid, organic quaternary ammonium base. Further example of specific catalyst are acetic acid, propionic acid, phosphoric acid, or tetramethylammonium hydroxide. The reaction may be heated at a suitable temperature for a suitable length of time till the reaction is complete. Reaction temperatures can range from about 25° C. to about 170° C. The reaction times can range from about 10 minutes to about 24 hours. Alcohols used in the preparation of the polymer include alcohols such as, for example, ethanol, isopropanol, n-butanol, isobutanol, t-butanol, 1,2-propanediol, 1,2,3-propanetriol, ethyl lactate, propylene glycol monomethyl ether, 2-ethoxyethanol, 1-methoxy-2-propanol, 2-methyl-2-propanol, and the like, and mixtures thereof. The silanes may contain the self-crosslinking functionality and the chromophore in the monomers or may be incorporated into a formed siloxane polymer by reacting it with the compound or compounds containing the functionality or functionalities. The silanes may contain other groups such as halides, hydroxyl, OC(O)R⁴, alkylketoxime, aryl, alkylaryl, alkoxy, acyl and acyloxy; where R⁴ is selected from alkyl, unsubstituted aryl and substituted aryl, which are the unreacted substituents of the silane monomer. The novel polymer may contain unreacted and/or hydrolysed residues from the silanes, that is, silicon with end groups such as hydroxyl, hydrogen, halide (e.g. chloride or fluoride), acyloxy, or OR^{E}, where R^{a} is selected from (C₁-C₁₀) alkyl, C(O)R^{b}, NR^{b}(R^{c}) and aryl, and R^{b} and R^{c} are independently (C₁-C₁₀) or aryl. These residues could be of the structure, (XSi(Y)Oₓ) where X and Y are independently selected from OH, H, OSi—, OR^{a}, where R^{a} is selected from (C₁-C₁₀) alkyl, unsubstituted aryl, substituted aryl, C(O)R^{b}, NR^{b}(R^{c}), halide, acyloxy, acyl, oxime, and aryl, and R^{b} and R^{c} are independently (C₁-C₁₀) or aryl, Y can also be R¹ and/or R² (as described previously), and x=½ or 1.

Examples of the silane reactants include:

(a) dimethoxysilane, diethoxysilane, dipropoxysilane, diphenyloxysilane, methoxyethoxysilane, methoxypropoxysilane, methoxyphenyloxysilane, ethoxypropoxysilane, ethoxyphenyloxysilane, methyl dimethoxysilane, methyl methoxyethoxysilane, methyl diethoxysilane, methyl methoxypropoxysilane, methyl methoxyphenyloxysilane, ethyl dipropoxysilane, ethyl methoxypropoxysilane, ethyl diphenyloxysilane, propyl dimethoxysilane, propyl methoxyethoxysilane, propyl ethoxypropoxysilane, propyl diethoxysilane, propyl diphenyloxysilane, butyl dimethoxysilane, butyl methoxyethoxysilane, butyl diethoxysilane, butyl ethoxypropoxysilane, butyl dipropoxysilane, butyl methylphenyloxysilane, dimethyl dimethoxysilane, dimethyl methoxyethoxysilane, dimethyl diethoxysilane, dimethyl diphenyloxysilane, dimethyl ethoxypropoxysilane, dimethyl dipropoxysilane, diethyl dimethoxysilane, diethyl methoxypropoxysilane, diethyl diethoxysilane, diethyl ethoxypropoxysilane, dipropyl dimethoxysilane, dipropyl diethoxysilane, dipropyl diphenyloxysilane, dibutyl dimethoxysilane, dibutyl diethoxysilane, dibutyl dipropoxysilane, dibutyl methoxyphenyloxysilane, methyl ethyl dimethoxysilane, methyl ethyl diethoxysilane, methyl ethyl dipropoxysilane, methyl ethyl diphenyloxysilane, methyl propyl dimethoxysilane, methyl propyl diethoxysilane, methyl butyl dimethoxysilane, methyl butyl diethoxysilane, methyl butyl dipropoxysilane, methyl ethyl ethoxypropoxysilane, ethyl propyl dimethoxysilane, ethyl propyl methoxyethoxysilane, dipropyl dimethoxysilane, dipropyl methoxyethoxysilane, propyl butyl dimethoxysilane, propyl butyl diethoxysilane, dibutyl methoxyethoxysilane, dibutyl methoxypropoxysilane, dibutyl ethoxypropoxysilane, trimethoxysilane, triethoxysilane, tripropoxysilane, triphenyloxysilane, dimethoxymonoethoxysilane, diethoxymonomethoxysilane, dipropoxymonomethoxysilane, dipropoxymonoethoxysilane, diphenyloxymonomethoxysilane, diphenyloxymonoethoxysilane, diphenyloxymonopropoxysilane, methoxyethoxypropoxysilane, monopropoxydimethoxysilane, monopropoxydiethoxysilane, monobutoxydimethoxysilane, monophenyloxydiethoxysilane, methyl trimethoxysilane, methyl triethoxysilane, methyl tripropoxysilane, ethyl trimethoxysilane, ethyl tripropoxysilane, ethyl triphenyloxysilane, propyl trimethoxysilane, propyl triethoxysilane, propyl triphenyloxysilane, butyl trimethoxysilane, butyl triethoxysilane, butyl tripropoxysilane, butyl triphenyloxysilane, methyl monomethoxydiethoxysilane, ethyl monomethoxydiethoxysilane, propyl monomethoxydiethoxysilane, butyl monomethoxydiethoxysilane, methyl monomethoxydipropoxysilane, methyl monomethoxydiphenyloxysilane, ethyl monomethoxydipropoxysilane, ethyl monomethoxy diphenyloxysilane, propyl monomethoxydipropoxysilane, propyl monomethoxydiphenyloxysilane, butyl monomethoxy dipropoxysilane, butyl monomethoxydiphenyloxysilane, methyl methoxyethoxypropoxysilane, propyl methoxyethoxy propoxysilane, butyl methoxyethoxypropoxysilane, methyl monomethoxymonoethoxybutoxysilane, ethyl monomethoxymonoethoxy monobutoxysilane, propyl monomethoxymonoethoxy monobutoxysilane, butyl monomethoxymonoethoxy monobutoxysilane, tetramethoxysilane, tetraethoxysilane, tetrapropoxysilane, tetrabutoxysilane, tetraphenyloxysilane, trimethoxymonoethoxysilane, dimethoxydiethoxysilane, triethoxymonomethoxysilane, trimethoxymonopropoxysilane, monomethoxytributoxysilane, monomethoxytriphenyloxysilane, dimethoxydipropoxysilane, tripropoxymonomethoxysilane, trimethoxymonobutoxysilane, dimethoxydibutoxysilane, triethoxymonopropoxysilane, diethoxydipropoxysilane, tributoxymonopropoxysilane, dimethoxymonoethoxy monobutoxysilane, diethoxymonomethoxy monobutoxysilane, diethoxymonopropoxymonobutoxysilane, dipropoxymonomethoxy monoethoxysilane, dipropoxymonomethoxy monobutoxysilane, dipropoxymonoethoxymonobutoxysilane, dibutoxymonomethoxy monoethoxysilane, dibutoxymonoethoxy monopropoxysilane and monomethoxymonoethoxymonopropoxy monobutoxysilane, and oligomers thereof.

(b) Halosilanes, including chlorosilanes, such as trichlorosilane, methyltrichlorosilane, ethyltrichlorosilane, phenyltrichlorosilane, tetrachlorosilane, dichlorosilane, methyldichlorosilane, dimethyldichlorosilane, chlorotriethoxysilane, chlorotrimethoxysilane, chloromethyltriethoxysilane, chloroethyltriethoxysilane, chlorophenyltriethoxysilane, chloromethyltrimethoxysilane, chloroethyltrimethoxysilane, and chlorophenyltrimethoxysilane are also used as silane reactants. In addition, silanes that can undergo hydrolysis and condensation reactions such as acyloxysilanes, or alkylketoximesilanes, are also used as silane reactants.

(c) Silanes bearing epoxy functionality, include 2-(3,4-epoxycyclohexyl)ethyl-trimethoxysilane, 2-(3,4-epoxycyclohexyl)ethyl-triethoxysilane, 2-(3,4-epoxycyclohexyl)ethyl-tripropoxysilane, 2-(3,4-epoxycyclohexyl)ethyl-triphenyloxysilane, 2-(3,4-epoxycyclohexyl)ethyl-diethoxymethoxysilane, 2-(3,4-epoxycyclohexyl)ethyl-dimethoxyethoxysilane, 2-(3,4-epoxycyclohexyl)ethyl-trichlorosilane, 2-(3,4-epoxycyclohexyl)ethyl-triacetoxysilane, (glycidyloxypropyl)-trimethoxysilane, (glycidyloxypropyl)-triethoxysilane, (glycidyloxypropyl)-tripropoxysilane, (glycidyloxypropyl)-triphenyloxysilane, (glycidyloxypropyl)-diethoxymethoxysilane, (glycidyloxypropyl)-dimethoxyethoxysilane, (glycidyloxypropyl)-trichlorosilane, and (glycidyloxypropyl)-triacetoxysilane

(d) Silanes bearing chromophore functionality, include phenyl dimethoxysilane, phenyl methoxyethoxysilane, phenyl diethoxysilane, phenyl methoxypropoxysilane, phenyl methoxyphenyloxysilane, phenyl dipropoxysilane, anthracyl dimethoxysilane, anthracyl diethoxysilane, methyl phenyl dimethoxysilane, methyl phenyl diethoxysilane, methyl phenyl dipropoxysilane, methyl phenyl diphenyloxysilane, ethyl phenyl dimethoxysilane, ethyl phenyl diethoxysilane, methyl anthracyl dimethoxysilane, ethyl anthracyl diethoxysilane, propyl anthracyl dipropoxysilane, methyl phenyl ethoxypropoxysilane, ethyl phenyl methoxyethoxysilane, diphenyl dimethoxysilane, diphenyl methoxyethoxysilane, phenyl trimethoxysilane, phenyl triethoxysilane, phenyl tripropoxysilane, anthracyl trimethoxysilane, anthracyl tripropoxysilane, phenyl triphenyloxysilane, phenyl monomethoxydiethoxysilane, anthracyl monomethoxydiethoxysilane, phenyl monomethoxydipropoxysilane, phenyl monomethoxydiphenyloxysilane, anthracyl monomethoxydipropoxysilane, anthracyl monomethoxy diphenyloxysilane, phenyl methoxyethoxypropoxysilane, anthracyl methoxyethoxypropoxysilane, phenyl monomethoxymonoethoxymonobutoxysilane, and anthracyl monomethoxymonoethoxymonobutoxysilane, and oligomers thereof.

Preferred among these compounds are triethoxysilane, tetraethoxysilane, methyltriethoxysilane, dimethyldiethoxysilane, tetramethoxysilane, methyltrimethoxysilane, trimethoxysilane, dimethyldimethoxysilane, phenyltriethoxysilane, phenyltrimethoxysilane, diphenyldiethoxysilane, diphenyldimethoxysilane, 2-(3,4-epoxycyclohexyl)ethyl-trimethoxysilane, 2-(3,4-epoxycyclohexyl)ethyl-triethoxysilane, (glycidyloxypropyl)-trimethoxysilane, (glycidyloxypropyl)-triethoxysilane, phenyl trimethoxysilane, phenyl triethoxysilane, and phenyl tripropoxysilane. In another embodiment the preferred monomers are triethoxysilane, tetraethoxysilane, methyltriethoxysilane, tetramethoxysilane, methyltrimethoxysilane, trimethoxysilane, phenyltriethoxysilane, phenyltrimethoxysilane, diphenyldiethoxysilane, and diphenyldimethoxysilane, 2-(3,4-epoxycyclohexyl)ethyl-trimethoxysilane, 2-(3,4-epoxycyclohexyl)ethyl-triethoxysilane.

After the siloxane polymer is made using the process herein, the siloxane polymer can be used to formulate an antireflective coating composition that can be used to form an underlayer for use under a photoresist. These compositions are more fully disclosed in U.S. patent application Ser. No. 11/425,813, filed Jun. 22, 2006, the contents of which are incorporated herein by reference. The antireflective coating composition includes, in addition to the siloxane polymer, an acid generator and a solvent. Typically, the antireflective coating composition will contain about 1 weight % to about 15 weight % of the siloxane polymer made by the process herein. The acid generator, may be incorporated in a range from about 0.1 to about 10 weight % by total solids of the antireflective coating composition. Suitable solvents include those which are typically used in the electronic materials industry, such as for example, a glycol ether derivative such as ethyl cellosolve, methyl cellosolve, propylene glycol monomethyl ether, diethylene glycol monomethyl ether, diethylene glycol monoethyl ether, dipropylene glycol dimethyl ether, propylene glycol n-propyl ether, or diethylene glycol dimethyl ether; a glycol ether ester derivative such as ethyl cellosolve acetate, methyl cellosolve acetate, or propylene glycol monomethyl ether acetate; carboxylates such as ethyl acetate, n-butyl acetate and amyl acetate; carboxylates of di-basic acids such as diethyloxylate and diethylmalonate; dicarboxylates of glycols such as ethylene glycol diacetate and propylene glycol diacetate; and hydroxy carboxylates such as methyl lactate, ethyl lactate, ethyl glycolate, and ethyl-3-hydroxy propionate; a ketone ester such as methyl pyruvate or ethyl pyruvate; an alkoxycarboxylic acid ester such as methyl 3-methoxypropionate, ethyl 3-ethoxypropionate, ethyl 2-hydroxy-2-methylpropionate, or methylethoxypropionate; a ketone derivative such as methyl ethyl ketone, acetyl acetone, cyclopentanone, cyclohexanone or 2-heptanone; a ketone ether derivative such as diacetone alcohol methyl ether; a ketone alcohol derivative such as acetol or diacetone alcohol; lactones such as butyrolactone; an amide derivative such as dimethylacetamide or dimethylformamide, anisole, and mixtures thereof.

The composition may further contain a photoacid generator, examples of which without limitation, are onium salts, sulfonate compounds, nitrobenzyl esters, triazines, etc. in addition to the acid generator in the composition, as well as other components such as, for example, monomeric dyes, lower alcohols, crosslinking agents, surface leveling agents, adhesion promoters, antifoaming agents, etc. The acid generator of the novel composition is a thermal acid generator capable of generating a strong acid upon heating. The thermal acid generator (TAG) used herein may be any one or more that upon heating generates an acid which can react with the cyclic ether and propagate crosslinking of the polymer present in the invention, particularly preferred is a strong acid such as a sulfonic acid. Preferably, the thermal acid generator is activated at above 90° C. and more preferably at above 120° C., and even more preferably at above 150° C. The photoresist film is heated for a sufficient length of time to react with the coating. Examples of thermal acid generators are metal-free iodonium and sulfonium salts, such as in FIG. 4. Examples of TAGs are nitrobenzyl tosylates, such as 2-nitrobenzyl tosylate, 2,4-dinitrobenzyl tosylate, 2,6-dinitrobenzyl tosylate, 4-nitrobenzyl tosylate; benzenesulfonates such as 2-trifluoromethyl-6-nitrobenzyl 4-chlorobenzenesulfonate, 2-trifluoromethyl-6-nitrobenzyl 4-nitro benzenesulfonate; phenolic sulfonate esters such as phenyl, 4-methoxybenzenesulfonate; alkyl ammonium salts of organic acids, such as triethylammonium salt of 10-camphorsulfonic acid. Iodonium salts are preferred and can be exemplified by iodonium fluorosulfonates, iodonium tris(fluorosulfonyl)methide, iodonium bis(fluorosulfonyl)methide, iodonium bis(fluorosulfonyl)imide, iodonium quaternary ammonium fluorosulfonate, iodonium quaternary ammonium tris(fluorosulfonyl)methide, and iodonium quaternary ammonium bis(fluorosulfonyl)imide. A variety of aromatic (anthracene, naphthalene or benzene derivatives) sulfonic acid amine salts can be employed as the TAG, including those disclosed in U.S. Pat. Nos. 3,474,054, 4,200,729, 4,251,665 and 5,187,019. Preferably the TAG will have a very low volatility at temperatures between 170-220° C. Examples of TAGs are those sold by King Industries under Nacure and CDX names. Such TAG's are Nacure 5225, and CDX-2168E, which is a dodecylbenzene sulfonic acid amine salt supplied at 25-30% activity in propylene glycol methyl ether from King Industries, Norwalk, Conn. 06852, USA. Strong acids with pKa in the range of about −1 to about −16 are preferred, and strong acids with pKa in the range of about −10 to about −16 are more preferred.

Since the antireflective film is coated on top of the substrate where slight metal contamination can destroy electrical properties of the product, it is envisioned that the film is of sufficiently low metal ion level and of sufficient purity that the properties of the semiconductor device are not adversely affected. Treatments such as passing a solution of the polymer through an ion exchange column, filtration, and extraction processes can be used to reduce the concentration of metal ions and to reduce particles.

The absorption parameter (k) of the composition containing the polymers made by the present process ranges from about 0.05 to about 1.0, preferably from about 0.1 to about 0.8 as measured using ellipsometry. The refractive index (n) of the antireflective coating is also optimized and can range from 1.3 to about 2.0, preferably 1.5 to about 1.8. The n and k values can be calculated using an ellipsometer, such as the J. A. Woollam WVASE VU-32™ Ellipsometer. The exact values of the optimum ranges for k and n are dependent on the exposure wavelength used and the type of application. Typically for 193 nm the preferred range for k is 0.05 to 0.75, and for 248 nm the preferred range for k is 0.15 to 0.8.

The antireflective coating composition, formulated using the polymer made by the process herein, is coated on the substrate using techniques well known to those skilled in the art, such as dipping, spin coating or spraying. The film thickness of the antireflective coating ranges from about 15 nm to about 200 nm. The coating is further heated on a hot plate or convection oven for a sufficient length of time to remove any residual solvent and induce crosslinking, and thus insolubilizing the antireflective coating to prevent intermixing between the antireflective coatings. The preferred range of temperature is from about 90° C. to about 250° C. If the temperature is below 90° C. then insufficient loss of solvent or insufficient amount of crosslinking takes place, and at temperatures above 300° C. the composition may become chemically unstable. A film of photoresist is then coated on top of the uppermost antireflective coating and baked to substantially remove the photoresist solvent. An edge bead remover may be applied after the coating steps to clean the edges of the substrate using processes well known in the art.

The substrates over which the antireflective coatings are formed can be any of those typically used in the semiconductor industry. Suitable substrates include, without limitation, silicon, silicon substrate coated with a metal surface, copper coated silicon wafer, copper, aluminum, polymeric resins, silicon dioxide, metals, doped silicon dioxide, silicon nitride, tantalum, polysilicon, ceramics, aluminum/copper mixtures; gallium arsenide, low k dielectrics, non uniform films such as those with high free volume for further lowering the dielectric constant, and other such Group III/V compounds. The substrate may comprise any number of layers made from the materials described above.

Photoresists can be any of the types used in the semiconductor industry, provided the photoactive compound in the photoresist and the antireflective coating absorb at the exposure wavelength used for the imaging process. These photoresists are well known to those having ordinary skill in the art and are further described in U.S. patent application Ser. No. 11/425,813, filed Jun. 22, 2006, referenced above.

After the coating process, the photoresist is imagewise exposed. The exposure may be done using typical exposure equipment. The exposed photoresist is then developed in an aqueous developer to remove the treated photoresist. The developer is preferably an aqueous alkaline solution comprising, for example, tetramethyl ammonium hydroxide. The developer may further comprise surfactant(s). An optional heating step can be incorporated into the process prior to development and after exposure.

The process of coating and imaging photoresists is well known to those skilled in the art and is optimized for the specific type of resist used. The patterned substrate can then be dry etched with an etching gas or mixture of gases, in a suitable etch chamber to remove the exposed portions of the antireflective film, with the remaining photoresist acting as an etch mask. Various etching gases are known in the art for etching organic antireflective coatings, such as those comprising CF₄, CF₄/O₂, CF₄/CHF₃, or Cl₂/O₂.

Each of the documents referred to above are incorporated herein by reference in its entirety, for all purposes. These examples are not intended, however, to limit or restrict the scope of the invention in any way and should not be construed as providing conditions, parameters or values which must be utilized exclusively in order to practice the present invention.

### EXAMPLES

SSQ polymers prepared in alcohol or non-alcohol solvents were described in Examples 1-9 and Comparative Examples 1-2, respectively. The weight average molecular weights were determined by gel permeation chromatography using polystyrenes as references.

### Example 1

In a three-neck 100 mL round-bottom flask equipped with a magnetic stirrer, thermometer, and condenser, was charged 7.00 g of 2-(3,4-epoxycyclohexyl)ethyl-trimethoxysilane (28 mmol), 1.70 g of phenyltrimethoxysilane (9 mmol), and 0.9 g of methyltrimethoxysilane (7 mmol). To the flask, was added a mixture of 1.18 g of D.I. water, 0.40 g of acetic acid, and 3.54 g of isopropanol. The mixture was heated to reflux and kept at that temperature for 3 hours. Then, the mixture was cooled to room temperature. The solvents were removed under reduced pressure to afford 7.76 g of a colorless liquid resin. The weight average molecular weight was approximately 13,450 g/mol, determined by gel permeation chromatography using polystyrenes as references.

### Comparative Example 1

In a three-neck 100 mL round-bottom flask equipped with a magnetic stirrer, thermometer, and condenser, was charged 7.00 g of 2-(3,4-epoxycyclohexyl)ethyl-trimethoxysilane (28 mmol), 1.70 g of phenyltrimethoxysilane (9 mmol), and 0.9 g of methyltrimethoxysilane (7 mmol). To the flask, was added a mixture of 1.18 g of D.I. water, 0.40 g of acetic acid, and 3.54 g of THF. The mixture was heated to reflux and kept at that temperature for 3 hours. Then, the mixture was cooled to room temperature. The solvents were removed under reduced pressure to afford 7.76 g of a colorless liquid resin. The weight average molecular weight was approximately 131,610 g/mol, determined by gel permeation chromatography using polystyrenes as references.

### Example 2

In a three-neck 250 mL round-bottom flask equipped with a magnetic stirrer, thermometer, and condenser, was charged 35.00 g of 2-(3,4-epoxycyclohexyl)ethyl-trimethoxysilane (142 mmol), 8.50 g of phenyltrimethoxysilane (43 mmol), and 4.50 g of methyltrimethoxysilane (33 mmol). To the flask, was added a mixture of 5.90 g of D.I. water, 2.00 g of acetic acid, and 17.7 g of isopropanol. The mixture was heated to reflux and kept at that temperature for 3 hours. Then, the mixture was cooled to room temperature. The solvents were removed under reduced pressure to afford 41.0 g of a colorless liquid resin. The weight average molecular weight was approximately 9,570 g/mol, determined by gel permeation chromatography using polystyrenes as references.

4.90 g of the polymer prepared in this example and 0.10 g of N-phenyldiethanolammonium nonaflate were dissolved in a mixture of propylene glycol monomethyl ether acetate (PGMEA) and propylene glycol monomethyl ether (PGME) to achieve 4.0 wt. % of total solids, forming a homogeneous solution. This homogeneous solution was spin-coated on a silicon wafer at 1200 rpm. The coated wafer was baked on a hotplate at 225° C. for 90 seconds. Then, n and k values were measured with a VASE Ellipsometer manufactured by J. A. Woollam Co. Inc. The optical constants n and k of the Si-containing film for 193 nm radiation were 1.734 and 0.191, respectively.

2.0 g of the polymer of this example and 0.04 g of diphenyliodonium perfluoro-1-butanesulfonate were dissolved in a mixture of propylene glycol monomethyl ether acetate (PGMEA) and propylene glycol monomethyl ether (PGME) (70/30 PGMEA/PGME) to achieve 6.2 wt % of total solids and filtered. This homogeneous solution was spin-coated on a silicon wafer at 1200 rpm. The coated wafer was baked on hotplate at 225° C. for 90 seconds. Then, n and k values were measured with a VASE Ellipsometer manufactured by J. A. Woollam Co. Inc. The optical constants n and k of the Si-containing film for 193 nm radiation were 1.728 and 0.209 respectively.

4.90 g of the polymer of this example and 0.10 g of N-phenyldiethanolammonium nonaflate were dissolved in a mixture of PGMEA and PGME (70/30 PGMEA/PGME) to achieve 5.0 wt. % of total solids. This homogeneous solution was spin-coated on a silicon wafer at 1200 rpm. The coated wafer was baked on hotplate at 250° C. for 90 seconds. Then, n and k values were measured with a VASE Ellipsometer manufactured by J. A. Woollam Co. Inc. The optical constants n and k values of the Si-containing film for 193 nm radiation were 1.721 and 0.155, respectively.

### Comparative Example 2

In a three-neck 100 mL round-bottom flask equipped with a magnetic stirrer, thermometer, and condenser, was charged 35.00 g of 2-(3,4-epoxycyclohexyl)ethyl-trimethoxysilane (142 mmol), 8.50 g of phenyltrimethoxysilane (43 mmol), and 4.50 g of methyltrimethoxysilane (33 mmol). To the flask, was added a mixture of 7.90 g of D.I. water, 2.00 g of acetic acid, and 23.70 g of THF. The mixture was heated to reflux and kept at that temperature for 3 hours. Then, the mixture was cooled to room temperature. The polymer gelled during the removal of solvent under reduced pressure at 60° C.

### Example 3

In a three-neck 250 mL round-bottom flask equipped with a magnetic stirrer, thermometer, and condenser, was charged 28.00 g of 3-(trimethoxysilyl)propyl methacrylate (113 mmol), 6.50 g of phenyltrimethoxysilane (33 mmol), and 2.00 g of methyltrimethoxysilane (15 mmol). To the flask, was added a mixture of 4.40 g of D.I. water, 1.50 g of acetic acid, and 14.10 g of isopropanol. The mixture was heated to reflux and kept at that temperature for 1.5 hours. Then, the mixture was cooled to room temperature. The solvents were removed under reduced pressure to afford 28.86 g of a colorless liquid resin. The weight average molecular weight was approximately 2,920 g/mol, determined by gel permeation chromatography using polystyrenes as references.

### Example 4

In a three-neck 250 mL round-bottom flask equipped with a magnetic stirrer, thermometer, and condenser, was charged 9.00 g of 2-(3,4-epoxycyclohexyl)ethyl-trimethoxysilane (37 mmol), 7.20 g of phenyltrimethoxysilane (36 mmol), 11.50 g of acetoxyethyltrimethoxysilane (55 mmol), and 9.00 g of triethoxysilane (55 mmol). To the flask, was added a mixture of 5.00 g of deionized water, 1.60 g of acetic acid, and 15 g of isopropanol. The mixture was heated to reflux and kept at that temperature for 3 hours. Then, the mixture was cooled to room temperature. The volatiles were removed under reduced pressure. The weight average molecular weight was approximately 18,950 g/mol, determined by gel permeation chromatography using polystyrenes as references.

1.5 g of the polymer prepared in this example and 0.015 g of diphenyliodonium perfluoro-1-butanesulfonate was dissolved in a mixture of propylene glycol monomethyl ether acetate (PGMEA) and propylene glycol monomethyl ether (PGME) to achieve 6.06 wt. % of total solids, forming a homogeneous solution. This homogeneous solution was spin-coated on a silicon wafer at 1500 rpm. The coated wafer was baked on a hotplate at 250° C. for 90 seconds. Then, n and k values were measured with a VASE Ellipsometer manufactured by J. A. Woollam Co. Inc. The optical constants n and k of the Si-containing film for 193 nm radiation were 1.744 and 0.234, respectively.

### Example 5

In a three-neck 250 mL round-bottom flask equipped with a magnetic stirrer, thermometer, and condenser, was charged 18.00 g of acetoxyethyltrimethoxysilane (86 mmol), 9.00 g of phenyltrimethoxysilane (45 mmol), and 16.00 g of triethoxysilane (97 mmol). To the flask, was added a mixture of 6.30 g of deionized water, 2.00 g of acetic acid, and 19 g of isopropanol. The mixture was heated to reflux and kept at that temperature for 3 hours. Then, the mixture was cooled to room temperature. The solvents were removed under reduced pressure to afford 27.64 g of a colorless liquid resin. The weight average molecular weight was approximately 3,070 g/mol, determined by gel permeation chromatography using polystyrenes as references.

1.5 g of the SSQ polymer prepared in this example was dissolved in a mixture of propylene glycol monomethyl ether acetate (PGMEA) and propylene glycol monomethyl ether (PGME) to achieve 5.0 wt. % of total solids, forming a homogeneous solution. This homogeneous solution was spin-coated on a silicon wafer at 1500 rpm. The coated wafer was baked on a hotplate at 250° C. for 90 seconds. Then, n and k values were measured with a VASE Ellipsometer manufactured by J. A. Woollam Co. Inc. The optical constants n and k of the Si-containing film for 193 nm radiation were 1.772 and 0.304, respectively.

### Example 6

In a three-neck 250 mL round-bottom flask equipped with a magnetic stirrer, thermometer, and condenser, was charged 12.20 g of 2-(3,4-epoxycyclohexyl)ethyl-trimethoxysilane (50 mmol) and 10.00 g of phenyltrimethoxysilane (50 mmol). To the flask, was added a mixture of 15.00 g of deionized water, 2.50 g of acetic acid, and 53.70 g of propylene glycol monomethyl ether acetate (PGMEA) and propylene glycol monomethyl ether (PGME) (PGMEA:PGME=70:30). The mixture was heated to reflux. After 30 minutes, 31.50 g of tetraethoxysilane (151 mmol) was added dropwise. The mixture was kept at the reflux temperature for 6 hours. Then, the mixture was cooled to room temperature. The weight average molecular weight was approximately 55,330 g/mol, determined by gel permeation chromatography using polystyrenes as references.

Polymers prepared in alcohol or non-alcohol solvents are described above. Compared to Example 1 (Mw 13,450 g/mol) prepared in IPA, Comparative Example 1 using the same monomers prepared in THF, had a much higher MW=131,610 g/mol. Similarly, Example 2 prepared in IPA had a MW of 9,570 g/mol. However, Comparative Example 2 prepared in THF gelled during solvent removal. Therefore, these results demonstrated that better stability and hence manufacturability can be obtained if the polymer is prepared in alcohol solvent.

### Example 7

3.0 g of the epoxy siloxane polymer prepared in Example 2 and 0.03 g of diphenyliodonium cyclo(1,3-perfluoropropanedisulfone)imidate was dissolved in a mixture of propylene glycol monomethyl ether acetate (PGMEA) and propylene glycol monomethyl ether (PGME) (70/30 PGMEA/PGME) to achieve 5.5 wt % of total solids and filtered with a 0.2 μm membrane filter, forming a homogeneous solution. This homogeneous solution was spin-coated on a silicon wafer at 1500 rpm. The coated wafer was baked on a hotplate at 240° C. for 60 seconds. Then, n and k values were measured with a VASE Ellipsometer manufactured by J. A. Woollam Co. Inc. The optical constants n and k of the Si-containing film at 193 nm radiation were 1.72 and 0.22, respectively. The weight average molecular weight was approximately 4,140 g/mol, determined by gel permeation chromatography using polystyrenes as references.

The filtered solution was sealed in a 30 mL Nalgene HDPE bottle and stored in a water bath with temperature set at 40° C. for 7 days. This aged solution was coated using the procedure described above. No change in film thickness was observed when compared to unaged samples (Table 1). In addition, the optical constants n and k of the Si-containing film at 193 nm radiation were the same as before aging test. The weight average molecular weight of the aged sample was approximately 4,120 g/mol, determined by gel permeation chromatography using polystyrenes as references. The change in weight average molecular weight after aging test was approximately 0%.

TABLE 1
Film thickness and optical constants of unaged and aged
samples

| Sample | Film Thickness (Å) | n (193 nm) | k (193 nm) |
|---|---|---|---|
| Unaged | 1162 | 1.72 | 0.22 |
| Aged | 1160 | 1.72 | 0.22 |

### Example 8

In a three-neck 250 mL round-bottom flask, equipped with a magnetic stirrer, thermometer and condenser, was charged with 36.00 g of 2-(3,4-epoxycyclohexyl)ethyl-trimethoxysilane (146 mmol), 14.40 g of phenyltrimethoxysilane (73 mmol), 5.00 g of methyltrimethoxysilane (37 mmol), and 18.00 g of triethoxysilane. To the flask, was added a mixture of 10.00 g of DI water, 3.20 g of acetic acid, and 30.00 g of isopropanol. The mixture was heated to reflux and kept at that temperature for 3 hours. Then, the mixture was cooled to room temperature. The solvents were removed under reduced pressure to afford 58.68 g of a colorless liquid polymer.

3.0 g of the epoxy siloxane polymer prepared above and 0.03 g of diphenyliodonium cyclo(1,3-perfluoropropanedisulfone)imidate was dissolved in a mixture of propylene glycol monomethyl ether acetate (PGMEA) and propylene glycol monomethyl ether (PGME) (70/30 PGMEA/PGME) to achieve 5.5 wt % of total solids and filtered with a 0.2 μm membrane filter, forming a homogeneous solution. This homogeneous solution was spin-coated on a silicon wafer at 1500 rpm. The coated wafer was baked on a hotplate at 240° C. for 60 seconds. Then, n and k values were measured with a VASE Ellipsometer manufactured by J. A. Woollam Co. Inc. The optical constants n and k of the Si-containing film at 193 nm radiation were 1.72 and 0.24, respectively. The weight average molecular weight was approximately 17,450 g/mol, determined by gel permeation chromatography using polystyrenes as references.

The filtered solution was sealed in a 30 mL Nalgene HDPE bottle and stored in a water bath with temperature set at 40° C. for 7 days. This aged solution was coated using the procedure described above. Film thickness change was approximately 7 nm as compared to unaged sample (Table 2). In addition, the optical constants n and k of the Si-containing film at 193 nm radiation were the same as before aging test. The weight average molecular weight of the aged sample was approximately 18,920 g/mol, determined by gel permeation chromatography using polystyrenes as references. The change in weight average molecular weight after aging test was approximately 5.6%.

TABLE 2
Film thickness and optical constants of unaged and aged
samples

| Sample | Film Thickness (Å) | n (193 nm) | k (193 nm) |
|---|---|---|---|
| Unaged | 1528 | 1.72 | 0.24 |
| Aged | 1598 | 1.72 | 0.23 |

### Example 9

A three-neck 500 mL round-bottom flask, equipped with a magnetic stirrer, thermometer and condenser, was charged with 136.1 g of 2-(3,4-epoxycyclohexyl)ethyl-trimethoxysilane (552 mmol), 68.0 g of phenyltrimethoxysilane (343 mmol), and 136.0 g of methyltrimethoxysilane (1.0 mol). To the flask, was added a mixture of 43.0 g of deionized water (DI) water, 18.0 g of acetic acid, and 127 g of isopropanol. The mixture was heated to reflux and kept at that temperature for 3 hours. Then, the mixture was cooled to room temperature. The solvents were removed under reduced pressure to afford 258.7 g of a colorless liquid polymer. The weight average molecular weight was approximately 7,700 g/mol, determined by gel permeation chromatography using polystyrenes as references.

### Example 10

A three-neck 250 mL round-bottom flask, equipped with a magnetic stirrer, thermometer and condenser, was charged with 35.0 g of 2-(3,4-epoxycyclohexyl)ethyl-trimethoxysilane (142 mmol), 8.5 g of phenyltrimethoxysilane (43 mmol), and 4.5 g of triethoxysilane (27 mmol). To the flask, was added a mixture of 5.9 g of deionized water (DI) water, 2.0 g of acetic acid, and 17 g of isopropanol. The mixture was heated to reflux and kept at that temperature for 3 hours. Then, the mixture was cooled to room temperature. The solvents were removed under reduced pressure to afford 41.98 g of a colorless liquid polymer. The weight average molecular weight was approximately 4,490 g/mol, determined by gel permeation chromatography using polystyrenes as references.

### Example 11

A three-neck 100 mL round-bottom flask, equipped with a magnetic stirrer, thermometer and condenser, was charged with 7.56 g of (3-glycidyloxypropyl)trimethoxysilane (32 mmol) and 1.89 g of trimethoxy(2-phenylethyl)silane (8 mmol). To the flask, was added a mixture of 1.09 g of deionized water (DI) water, 0.25 g of acetic acid, and 2.50 g of isopropanol. The mixture was heated to reflux and kept at that temperature for 5 hours. Then, the mixture was cooled to room temperature. The solvents were removed under reduced pressure to afford 4.21 g of a colorless liquid polymer.

The above processes can be repeated using propylene glycol monomethyl ether as the reaction solvent and good results are expected.

The application is related to U.S. patent application Ser. No. 11/425,813, filed Jun. 22, 2006, the contents of which are hereby incorporated herein by reference.

The foregoing description of the invention illustrates and describes the present invention. Additionally, the disclosure shows and describes only certain embodiments of the invention but, as mentioned above, it is to be understood that the invention is capable of use in various other combinations, modifications, and environments and is capable of changes or modifications within the scope of the inventive concept as expressed herein, commensurate with the above teachings and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

1. A process for making a siloxane polymer which comprises at least one Si—OH group and at least one Si—OR group, where R is a moiety other than hydrogen, comprising reacting one or more silane reactants together in the presence of a hydrolysis catalyst in either a water/alcohol mixture or in one or more alcohols to form the siloxane polymer; and separating the siloxane polymer from the water/alcohol mixture or the alcohol(s).

2. The process of claim 1 where the, siloxane polymer comprises at least one chromophore, and at least one moiety selected from structure (1) and structure (2), 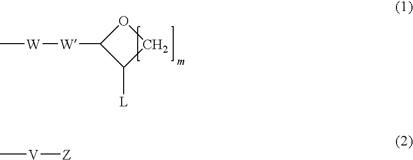
where m is 0 or 1; W and W′ are independently a valence bond or a connecting group linking the cyclic ether to the silicon of the polymer; L is selected from hydrogen, W′ and W, or L and W′ are combined to comprise a cycloaliphatic linking group linking the cyclic ether to the silicon of the polymer; V is a valence bond or a connecting group linking Z to the silicon of the polymer; Z is selected from O—C(═O)—R³⁰, unsubstituted or substituted alkenyl, and —N═C═O; and R³⁰ is unsubstituted or substituted alkyl or unsubstituted or substituted alkenyl.

3. The process of claim 1 where the siloxane polymer comprises one or more units of structures (i) and/or (ii)
—(R¹SiO_{h/2})— and —(R²SiO_{h/2})— (i),
—(R′(R″)SiO_{X})— (ii),
where h is 1, 2, or 3; and R¹ is independently a moiety selected from structure (1) and structure (2), 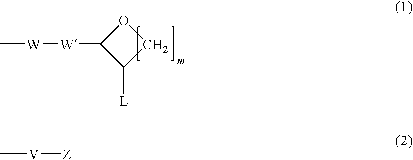
where m is 0 or 1; W and W′ are independently a valence bond or a connecting group linking the cyclic ether to the silicon of the polymer; L is selected from hydrogen, W′ and W, or L and W′ are combined to comprise a cycloaliphatic linking group linking the cyclic ether to the silicon of the polymer; V is a valence bond or a connecting group linking Z to the silicon of the polymer; Z is selected from O—C(═O)—R³⁰, unsubstituted or substituted alkenyl, and —N═C═O; and R³⁰ is unsubstituted or substituted alkyl or unsubstituted or substituted alkenyl; R² is a chromophore; R′ and R″ are independently selected from R¹ and R²; and x=½ or 1.

4. The process of claim 1, where the siloxane polymer comprises one or more units of structures (iii) and (iv)
-(A¹R¹SiO_{X})— (iii),
-(A²R²SiO_{X})— (iv),
where, R¹ is independently a moiety selected from structure (1) and structure (2), 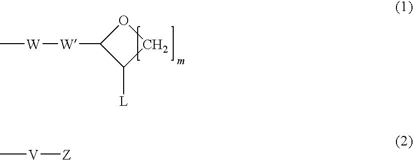
where m is 0 or 1; W and W′ are independently a valence bond or a connecting group linking the cyclic ether to the silicon of the polymer; L is selected from hydrogen, W′ and W, or L and W′ are combined to comprise a cycloaliphatic linking group linking the cyclic ether to the silicon of the polymer; V is a valence bond or a connecting group linking Z to the silicon of the polymer; Z is selected from O—C(═O)—R³⁰, unsubstituted or substituted alkenyl, and —N═C═O; and R³⁰ is unsubstituted or substituted alkyl or unsubstituted or substituted alkenyl; R² is a chromophore; x=½ or 1; A¹ and A² are independently hydroxyl, R′, R², halide, alkyl, OR⁴, OC(O)R⁴, unsubstituted or substituted alkylketoxime, unsubstituted aryl and substituted aryl, unsubstituted or substituted alkylaryl, unsubstituted or substituted alkoxy, unsubstituted or substituted acyl and unsubstituted or substituted acyloxy, and R⁴ is selected from unsubstituted alkyl, substituted alkyl, unsubstituted aryl and substituted aryl.

5. The process of claim 3, where the polymer further comprises one or more units selected from
—(R³SiO_{h/2})— (v),
where h is 1, 2, or 3; and R³ is independently, hydroxyl, hydrogen, halide, alkyl, OR⁴, OC(O)R⁴, unsubstituted or substituted alkylketoxime, unsubstituted or substituted aryl, unsubstituted or substituted alkylaryl, unsubstituted or substituted alkoxy, unsubstituted or substituted acyl and unsubstituted or substituted acyloxy, where R⁴ is selected from alkyl, unsubstituted aryl and substituted aryl,
—(SiO_{4/2})— (vi),
-((A¹)A²SiO_{X})— (vii),
where x=½ or 1, A¹ and A² are independently hydroxyl, hydrogen, halide, alkyl, OR⁴, OC(O)R⁴, unsubstituted or substituted alkylketoxime, unsubstituted or substituted aryl, unsubstituted or substituted alkoxy, unsubstituted or substituted alkylaryl, unsubstituted or substituted acyl and unsubstituted or substituted acyloxy; and mixtures of these units.

6. The process of claim 1, where the siloxane polymer comprises at least one unit of structure (viii)
—(R⁵SiO_{h/2})— (viii),
where h is 1, 2, or 3; and R⁵ is independently a moiety selected from structure (1), structure (2), and a chromophore, 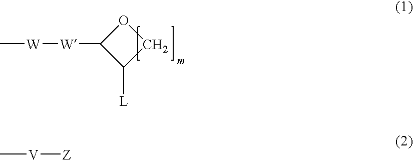
where m is 0 or 1; W and W′ are independently a valence bond or a connecting group linking the cyclic ether to the silicon of the polymer; L is selected from hydrogen, W′ and W, or L and W′ are combined to comprise a cycloaliphatic linking group linking the cyclic ether to the silicon of the polymer; V is a valence bond or a connecting group linking Z to the silicon of the polymer; Z is selected from O—C(═O)—R³⁰, unsubstituted or substituted alkenyl, and —N═C═O; and R³⁰ is unsubstituted or substituted alkyl or unsubstituted or substituted alkenyl.

7. The process of claim 1, where the siloxane polymer comprises the structure,
—(R¹SiO_{3/2})ₐ(R²SiO_{3/2})_{b}(R³SiO_{3/2})_{c}(SiO_{4/2})_{d}—
where, R¹ is independently a moiety selected from structure (1) and structure (2) 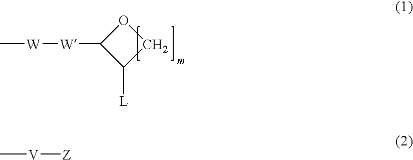
where m is 0 or 1; W and W′ are independently a valence bond or a connecting group linking the cyclic ether to the silicon of the polymer; L is selected from hydrogen, W′ and W, or L and W′ are combined to comprise a cycloaliphatic linking group linking the cyclic ether to the silicon of the polymer; V is a valence bond or a connecting group linking Z to the silicon of the polymer; Z is selected from O—C(═O)—R³⁰, unsubstituted or substituted alkenyl, and —N═C═O; and R³⁰ is unsubstituted or substituted alkyl or unsubstituted or substituted alkenyl; R² is a chromophore; R³ is independently, hydrogen, unsubstituted or substituted (C₁-C₁₀) alkyl, unsubstituted aryl, and substituted aryl; and 0<a<1; 0<b<1, 0≦c<1; and 0≦d<1.

8. The process of claim 1, wherein the alcohol is selected from ethanol, isopropanol, n-butanol, isobutanol, t-butanol, 1,2-propanediol, 1,2,3-propanetriol, ethyl lactate, propylene glycol monomethyl ether, propylene glycol monopropyl ether, 2-ethoxyethanol, 1-methoxy-2-propanol, 2-methyl-2-propanol, and mixtures thereof.

9. The process of claim 2, where the chromophore is selected from unsubstituted aromatic, substituted aromatic, unsubstituted heteroaromatic and substituted heteroaromatic moiety.

10. The process of claim 9, where the chromophore is selected from substituted or unsubstituted phenyl group, unsubstituted anthracyl group, a substituted or unsubstituted phenanthryl group, a substituted or unsubstituted naphthyl group, a sulfone-based compound, benzophenone-based compound, a substituted or an unsubstituted heterocyclic aromatic ring containing heteroatoms selected from oxygen, nitrogen, sulfur; and a mixture thereof.

11. The process of claim 1, wherein the siloxane polymer contains at least one structure selected from

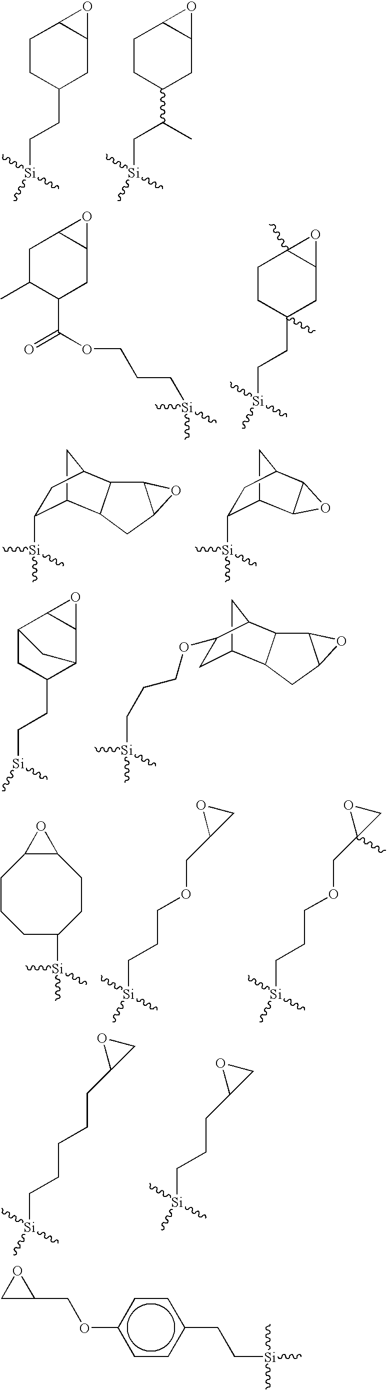

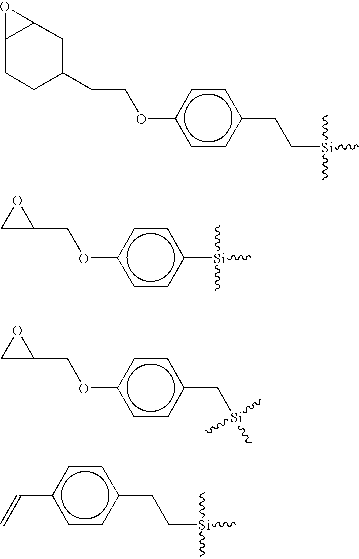

12. An antireflective coating composition comprising an acid generator and the siloxane polymer as defined in claim 1.

13. The antireflective coating composition of claim 12, where the acid generator is a thermal acid generator.

14. The antireflective coating composition of claim 12, where the acid generator is selected from an iodonium salt, sulfonium salt and ammonium salt.

15. The process of claim 1 where the siloxane polymer contains a chromophore.

16. The process of claim 15, where the chromophore is selected from unsubstituted aromatic, substituted aromatic, unsubstituted heteroaromatic and.

17. The process of claim 15, where the chromophore is selected from substituted or unsubstituted phenyl group, unsubstituted anthracyl group, a substituted or unsubstituted phenanthryl group, a substituted or unsubstituted naphthyl group, a sulfone-based compound, benzophenone-based compound, a substituted or an unsubstituted heterocyclic aromatic ring containing heteroatoms selected from oxygen, nitrogen, sulfur; and a mixture thereof.
